(19) United States
(12) Patent Application Publication
(10) Pub. No.: US 2009/0115198 A1
(43) Pub. Date: May 7, 2009

(54) LATCH DEVICE OF A DOOR

(75) Inventors: Kazuhiko Kitada, Yokohama-shi (JP); Yutaka Sugihara, Higashiosaka-shi (JP)

Correspondence Address: SUGHRUE MION, PLLC, 2100 PENNSYLVANIA AVENUE, N.W., SUITE 800, WASHINGTON, DC, 20037, US

(73) Assignee: Okamura Corporation, Yokohama-shi (JP)

(21) Appl. No.: 12/093,392

(22) PCT Filed: Nov. 7, 2006
(86) PCT No.: PCT/JP2006/322169

§ 371 Date: May 12, 2008

(30) Foreign Application Priority Data
Nov. 10, 2005 (JP) 2005-326098
Nov. 14, 2005 (JP) 2005-329319

(51) Int. Cl. E05C 3/22

(52) U.S. Cl. 292/198; 292/2

(57) ABSTRACT

A simply structured and smoothly operable latch device of a door in which a latch can be infallibly released by operating a handle from any of upper, lower, right, and left sides. The handle (1) having operation parts (1e) at the upper, lower, left, and right inner edges of the front opening part thereof is received in a handle receiving part (14) formed in a door (3) and having an opening in its front surface. The handle (1) can be moved to a non-operating position where the rear surface of the handle abuts on the rear end surface of the handle receiving part (14) or to an operating position where the handle (1) is tilted so that one of the upper and lower edges or one of the left and right edges is nearer to the person operating the handle (1) than the other. The handle (1) is biased toward the non-operating position by a spring (17), and the handle (1) and the latch are linked with each other by a linkage means (34) so that the latch can be moved to the non-engaging position when the handle (1) is moved to the operating position.

### TECHNICAL FIELD

The present invention relates to a latch device of a door in which a latch engages with and disengages from a housing when the door closes, a handle in a front panel of the door enabling a latch to engage with and disengage from the housing.

JP8-266348A discloses a door latch in which a handle pivotally mounted to a door is pulled to allow the handle to turn in one direction to release latch.

JP2004-332504A and JP63-96177U disclose that a latch is released by turning a handle from right and left or upper and lower directions.

However, the handle is limited to turn in one or two directions to make it impossible to release latch even if the handle is operated from other directions.

For example, in a storage system where a plurality of cabinets or lockers are piled up and arranged side by side, a handle at a higher position of a door for the cabinet is preferably operated from a lower position, and a handle at a lower position of the door is preferably operated from a higher position. A handle for a door at an intermediate-height position is preferably operated from a right or left direction to allow the latch to be released. All the handles should have the same structure and the same design.

To satisfy the requirements, handles are desirably operated from all directions for releasing latch.

### SUMMARY OF THE INVENTION

In view of the disadvantages, it is an object of the present invention to provide a door latch in which a handle is operated from any directions to allow latch to be released, its structure being simple and operable smoothly.

### BRIEF DESCRIPTION OF THE DRAWINGS

FIG. 1 is a perspective view of a storage system in which three cabinets A, B, C are piled up, each including a latch device of a door according to the present invention.

FIG. 2 is an enlarged horizontal sectional view taken along the line II-II in FIG. 1.

FIG. 3 is an enlarged front view of a handle of the door of the cabinet B.

FIG. 4 is a perspective view thereof.

FIG. 5 is an exploded perspective view thereof.

FIG. 6A is a vertical sectional side view taken along the line VI-VI in FIG. 1 when the handle is not operated.

FIG. 6B is a vertical sectional side view taken along the line VI-VI in FIG. 1 when the lower part of the handle is pulled.

FIG. 6C is a vertical sectional side view taken along the line VI-VI in FIG. 1 when the upper part of the handle is pulled.

FIG. 7A is a vertical sectional plan view taken along the line VII-VII in FIG. 1 when the handle is not operated.

FIG. 7B is a vertical sectional plan view taken along the line VII-VII in FIG. 1 when the left part of the handle is pulled.

FIG. 7C is a vertical sectional plan view taken along the line VII-VII in FIG. 1 when the right part of the handle is pulled.

FIG. 8 is an enlarged front view of a handle on the front surface of a drawer of the cabinet A in the second embodiment according to the present invention.

FIG. 9A is a vertical sectional side view taken along the line IX-IX in FIG. 8 when the handle is not operated.

FIG. 9B is a vertical sectional side view taken along the line IX-IX in FIG. 8 when the lower part of the handle is pulled.

FIG. 9C is a vertical sectional side view taken along the line IX-IX in FIG. 8 when the upper part of the handle is pulled.

FIG. 10A is a vertical sectional plan view taken along the line X-X in FIG. 8 when the handle is not operated.

FIG. 10B is a vertical sectional plan view taken along the line X-X in FIG. 8 when the left part of the handle is pulled.

FIG. 10C is a vertical sectional plan view taken along the line X-X in FIG. 8 when the right part of the handle is pulled.

FIG. 11 is a front view of a handle in a door in the third embodiment according to the present invention.

FIG. 12 is a vertical sectional side view taken along the line XII-XII in FIG. 11.

FIG. 13 is a vertical sectional side view similar to FIG. 12 when the upper part of the handle is pulled.

FIG. 14 is a horizontal sectional plan view of a handle of a door in the fourth embodiment according to the present invention.

FIG. 15 is a vertical sectional side view of a handle of a door in the fifth embodiment according to the present invention.

FIG. 16 is a vertical sectional side view of a handle of a door in the sixth embodiment according to the present invention.

FIG. 17 is a vertical sectional side view of a handle of a door in the seventh embodiment according to the present invention.

FIG. 18 is a vertical sectional side view of a handle of a door in the eighth embodiment according to the present invention.

FIG. 19 is a vertical sectional side view of a handle of a door in the ninth embodiment according to the present invention.

FIG. 20 is an exploded perspective view thereof.

FIG. 21A is a vertical sectional side view taken along the line XXI-XXI in FIG. 19 when the handle is not operated.

FIG. 21B is a vertical sectional side view taken along the line XXI-XXI in FIG. 19 when the lower part of the handle is pulled.

FIG. 21C is a vertical sectional side view taken along the line XXI-XXI in FIG. 19 when the upper part of the handle is pulled.

FIG. 22A is a vertical sectional plan view taken along the line XXII-XXII in FIG. 19 when the handle is not operated.

FIG. 22B is a vertical sectional plan view taken along the line XXII-XXII in FIG. 19 when the left part of the handle is pulled.

FIG. 22C is a vertical sectional plan view taken along the line XXII-XXII in FIG. 19 when the right part of the handle is pulled.

FIG. 23A is a horizontal sectional plan view of a handle in the tenth embodiment according to the present invention when the handle is not operated.

FIG. 23B is a horizontal sectional plan view of the handle in the tenth embodiment according to the present invention when the left-hand part of the handle is pressed rearward.

FIG. 24A is a horizontal sectional plan view of a handle in the eleventh embodiment according to the present invention when a handle is not operated.

FIG. 24B is a horizontal sectional plan view of a handle in the eleventh embodiment according to the present invention when left-hand part of the handle is pressed rearward.

### DETAILED DESCRIPTION OF PREFERRED EMBODIMENTS

Embodiments of the invention will be described with respect to the drawings.

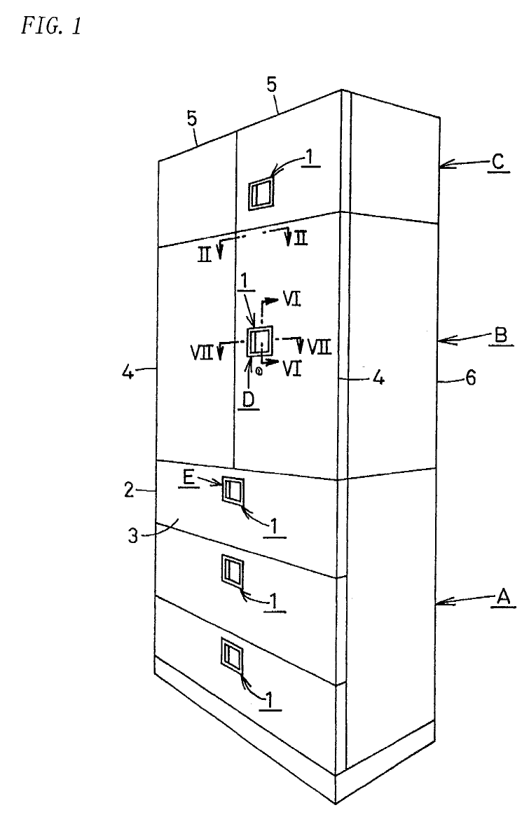

FIG. 1 shows a storage system in which three cabinets A, B, C are piled up, each having a latch device of a door.

The handles 1 for the cabinets A, B, C are all the same in structure and design. The latch devices including the handle 1 differ from each other in structure to comply with the cabinets A, B, C.

The cabinet A comprises three-stage drawers and the handle 1 is provided in the middle of a front panel of each of the drawers 2.

The cabinet B is a double-door type, and the right-hand door 4 has a handle 1.

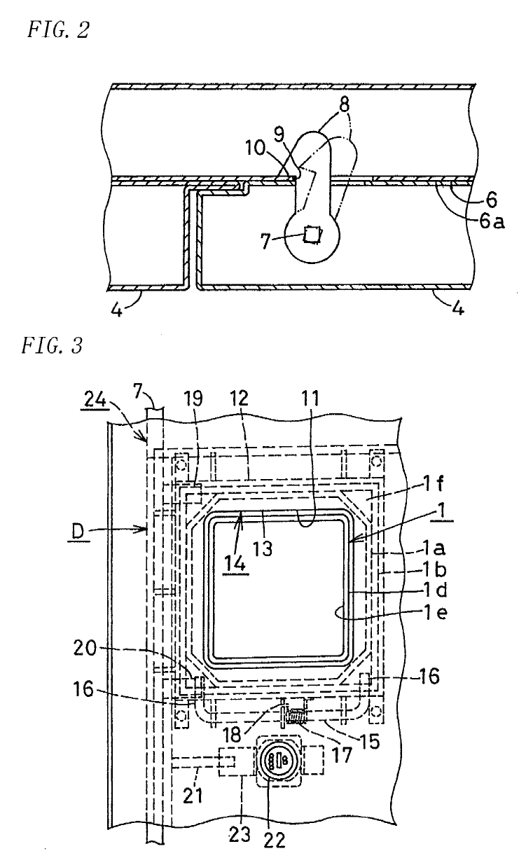

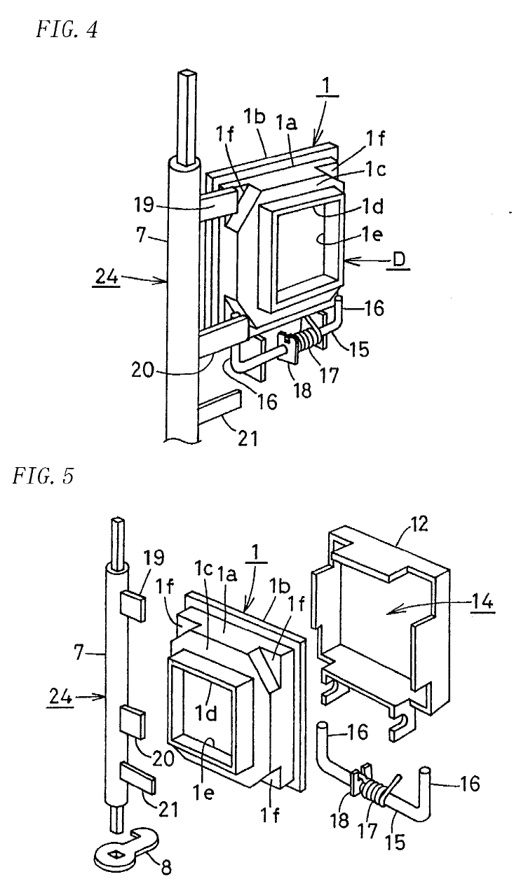

Then, a latch device D of the cabinet B will be described in detail with respect to FIGS. 2-7 as the first embodiment of the present invention. Then, a latch device E of the cabinet A will be described with respect to FIGS. 8-10 as the second embodiment of the present invention.

A latch device of the cabinet C has substantially the same structure as the latch device D of the cabinet D except partial size and description thereof is omitted.

In the cabinet B in FIGS. 2-5, the right-hand door 4 is pivotally mounted to a right side of a housing 6 with a hinge (not shown). A vertical rectangular latch shaft 7 is pivotally mounted in a left-hand side of the right-hand door 4. At the upper and lower ends of the latch shaft 7, the proximal end of the latch 8 is fixed.

In FIG. 2, the latch 8 projects rearward from the door 4 with a hooked rear end. When the door 4 is closed, the latch 8 engages in a hole 9 in the front surface of a top rail 6a. A lower latch 8 is disposed in a bottom rail (not shown).

In FIGS. 3 to 7, a square opening 11 for operating the handle 1 is formed in the front surface of the right-hand door 4, and a box-like handle storage case 12 is disposed behind the opening 11. Vertical and horizontal distances of a front opening of the handle storage case 12 are larger than those of the opening 11. When the handle storage case 12 is mounted in the door 4, the peripheral edge of the door 4 around the opening 11 is formed as an inward brim 13 projecting inward in the front opening of the handle storage case 12.

By the inward brim 13 and handle storage case 12, the handle 1 is stored to move between a rest position where its rear end face abuts on the bottom of the handle storage case 12, and a working position where the handle 1 is tilted to allow one end to be ahead of the other end in a rectangular handle storage portion 14.

The handle 1 comprises a rectangular portion 1a having an opening; a brim 1b which is corresponding to the inner surface of the handle storage case 1b; and an operating part 1e which comprises an inward portion 1c and a rectangular projection 1d.

The upper parts of the rectangular portion 1a are partially cut off at four corners to form a corner-cutout-flat portion 1f.

An operating rod 15 is pivotally mounted under the handle storage case 12. The upper ends of a pair of handle holding portions 16,16 extending from the ends of the operating rod 15 contact the front surfaces of the corner-cutout-flat portion 1f.

A coil spring 17 is wound on the middle of the operating rod 15. One end of the winding of the coil spring 17 engages in an engagement piece 18 fixed to the middle of the operating rod 15. The other end of the winding engages on the lower edge of the handle storage case 12. Thus, the operating rod 15 is urged by the coil spring 17 so that the ends of the handle holding portions 16,16 can rotate to push the lower corner-cutout-flat portions 1f, 1f rearward.

The handle 1 is pressed rearward by the handle holding portions 16,16 when it is not operated, and held in the rest position where the brim 1b contacts the rear end face of the handle storage portion 14.

Three arms 19,20,21 are fixed to the latch shaft 7 at suitable intervals vertically. The upper arm 19 abuts on the front surface of the upper-left corner-cutout-flat portion 1f of the handle 1. The middle arm 20 abuts on the front surface of the left handle holding portion 16.

The latch shaft 7 is urged to rotate to press the handle 1 with the arms 19,20 directly and to press the handle 1 with the handle holding portion 16 indirectly by a coil spring (not shown). When the handle 1 is in the rest position, the latch shaft 7 is positioned in an engagement position where the latch 8 engages on the engagement portion 10 as shown by a solid line in FIG. 2.

A key (not shown) is put into a cylinder lock 22 in the front panel of the door 4 to turn the cylinder lock 22, allowing a dead bolt 23 to move leftward. Thus, the left end of the dead bolt 23 gets in a turning track of the cylinder lock 21 for locking, or gets out of the turning track for unlocking.

In the embodiment, there is a connecting unit 24 for connecting the handle 1 to the latch 8 in which with the operating rod 15 having the handle holding portions 16,16 and with the latch shaft 7 having the arms 19,20 the handle 1 moves the latch 8 to a disengaged position where the latch 8 disengages from the engagement portion 10 of the housing 6. A latch device D comprises the latch 8, connecting unit 24, handle storage case 12, handle 1 and coil spring 17.

A operation of the embodiment will be described.

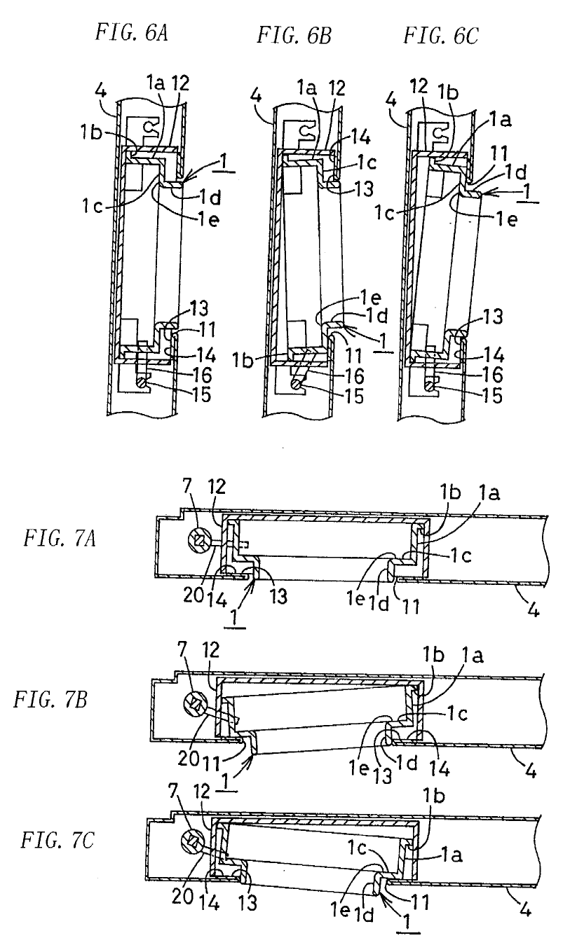

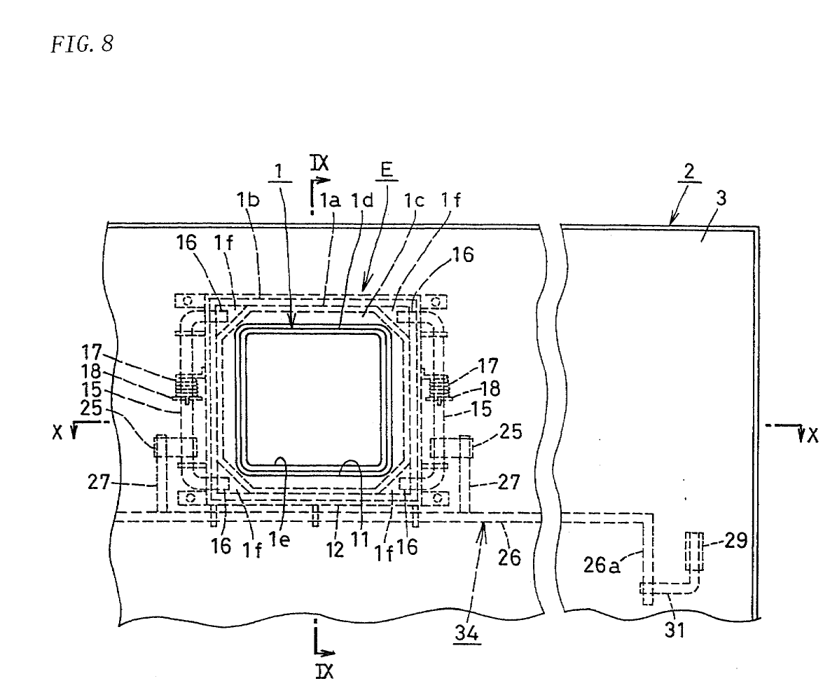

When the handle 1 does not work, it is in the rest position in FIGS. 6A and 7A, and the latch 8 and latch shaft 7 are in the engagement position by the solid line in FIG. 2.

From this position in FIG. 6A, the operating portion 1e of the handle 1 is pulled, the handle 1 is tilted on the upper rear end as pivot to allow the lower end to move forward until the front lower end of the rectangular portion 1a contacts the rear surface of the lower brim 13 to the working position where the lower edge is ahead of the upper edge.

When the lower end of the handle 1 moves forward, the handle holding portions 16,16 are turned by the corner-cutout-flat portions 1f,1f of the handle 1 against the torsion coil spring 17. The left-hand handle holding portion 16 turns to allow the middle arm 20 to turn forward. Thus, the latch 8 and the latch shaft 8 turn to the disengaged position where they disengage from the engaged portion 10 as shown by a dotted line in FIG. 2 to allow the door 4 to open.

When the left-hand part of the operating portion 1e of the handle 1 is pulled in FIG. 7B and when the right-hand part is pulled in FIG. 7C, one of the right and left ends of the rectangular portion 1a contacts the rear surface of the brim 13 of the opening 11.

With tilting of the handle 1, one of the right and left handle holding portions 16 is turned by one of the lower corner-cutout-flat portions 1f forward and downward. Then, the latch 6 turns to the disengaged position as well as in FIG. 6B to allow the door 4 to open.

In FIG. 6C, when the upper operating portion 1e of the handle 1 is pulled, the upper end is tilted forward about the rear lower end as pivot until the upper front end of the rectangular portion 1a contacts the rear surface of the upper brim 13.

The end of the upper arm 19 turns forward by the upper left corner-cutout-flat portion 1f of the handle 1 and the latch shaft 7 and latch 8 turns to the disengaged position to allow the door 4 to open.

Accordingly, when any one of the upper, lower, right-hand and left-hand operating portions 1e is pulled, the handle 1 is tilted to allow the latch 8 to move the disengaged position. Whenever the handle 1 is operated from any one of upper, lower, right and left directions, the latch 8 can surely be released to provide more convenient use.

In FIGS. 8-10, a latch device E in the second embodiment of the present invention is provided in a front panel 3 of each drawer 2 of the cabinet A.

The latch device E includes the same elements as those in the latch device D in the first embodiment with the same numerals and description thereof will be omitted. Only different elements will be described in detail. The other embodiments will be described as well.

In the latch device E, an opening 11 is formed in the middle of the front panel 3 and a handle storage case 12 is provided behind the opening 11. A rectangular handle storage portion 14 is formed in the case 12 and a handle 1 is stored in the portion 14 to tilt between a rest position and a working position. At each side of the handle 1 in the front panel 3, a pair of vertical operating rods 15,15 and torsion coil springs 17,17 are provided. The ends of upper and lower holding portions 16,16 extending from the upper and lower ends of each of the operating rods 15 contact the front surfaces of four corner-cutout-flat portions 1f of the handle 1.

A pair of projections 25,25 is fixed to the right and left operating rods 15,15.

Below the handle storage case 12 in the front panel 3, an operating shaft 26 extends horizontally and has a downward portion 26a,26a at each end.

The operating shaft 26 has a pair of arms 27,27 each end of which is behind the projection 25.

At each side of the front panel 3, a latch 29 projects from the front panel 3 rearward, has an engagement hole 28 and is pivotally mounted on a vertical shaft 30.

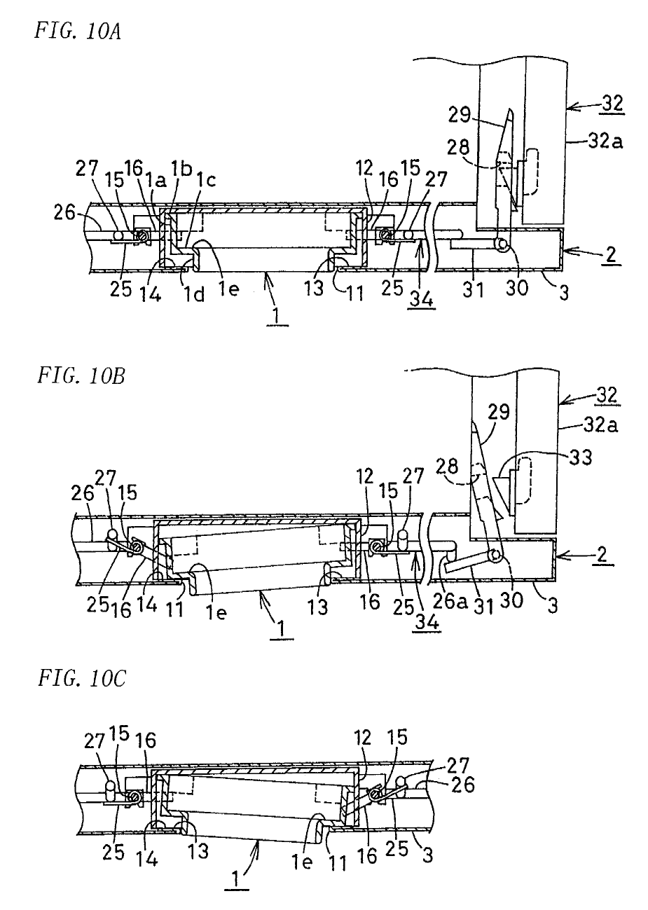

At the front end of the latch 29, an arm 31 turns together with the latch 29. The arm 31 turns forward by the bent portion 26a of the operating shaft 26. The latch 29 is pivoted from an engagement position where a hole 28 engages with a projection 33 fixed to the inner surface of a side panel 32a of the housing 32 in FIG. 10A to a disengaged position where the engagement hole 28 disengages from the projection 33.

The latch 29 is always urged toward the engagement position by a spring (not shown).

In the second embodiment, there is a connecting unit 34 connecting the handle 1 to the latch 29, comprising a pair of operating rods 15 comprising handle holding portions 16,16 and projection 25, and an operating shaft 26 comprising the arms 27,27 and bent portions 26a,26a. Thus, motion of the handle 1 to the working position allows the latch 29 to got to a disengaged position where the latch 29 disengages from the projection 33 of the housing 32. A latch device E comprises the latch 29, connecting unit 34, handle storage case 12, handle 1 and torsion coil spring 17.

Then, an operation of the latch device E will be described.

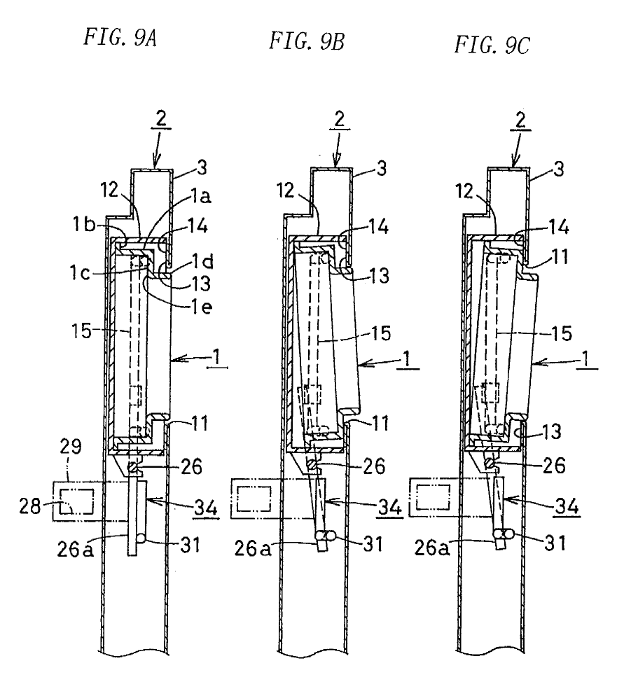

When the handle 1 does not operate, it is in a rest position in FIGS. 9A and 10A where the latch 29 engages with the projection 33.

From this position, in FIG. 9B, the operating portion 1e at the lower part of the handle 1 is pulled. The handle 1 is tilted to allow the lower end to move forward about the upper rear end to the working position where the lower edge is ahead of the upper edge until lower front end of a rectangular portion 1a contacts the rear surface of a brim 13 under an opening 11.

With forward motion of the lower portion of the handle 1, right and left handle holding portions 16,16 turn forward against force of a torsion coil spring 17 with corner-cutout-flat portions 1f,1f of the handle 1. With rotation of the right and left operating rods 15,15, right and left projections 25,25 press the upper ends of the right and left arms 27,27 rearward to allow the operating shaft 26 to rotate, so that the lower ends of the right and left bent portions 26a,26a go forward.

With forward rotation of the bent portion 26a, the arm 31 of the latch 29 is pushed forward and each of the latches 29 turns to the disengaged position in the right side of FIG. 10b to enable a drawer 2 to be pulled forward.

In FIG. 9C, when an upper operating portion 1e of the handle 1 is pulled, the upper holding portions 16,16 of the operating rods 15,15 are turned forward with upper corner-cutout-flat portions 1f,1f. So, in FIG. 10B, when left-side operating portion 1e of the handle 1 is pulled, upper and lower holding portions 16,16 of the left-hand operating rod is turned forward with left-hand upper and lower corner-cutout-flat portions 1f,1f of the handle 1. When the right-hand operating portion 1e of the handle 1 is pulled, upper and lower holding portions 16,16 of the right-hand operating portion 15 is turned forward with right-hand upper and lower corner-cutout-flat portions 1f,1f of the handle 1. Thus, one of the arms 27,27 is pressed rearward with the projection 25 of one of the operating rods 15, and then, as well as the embodiment in FIG. 9B, each of the latches 29 is turned to the disengaged position to enable the drawer 2 to be pulled forward.

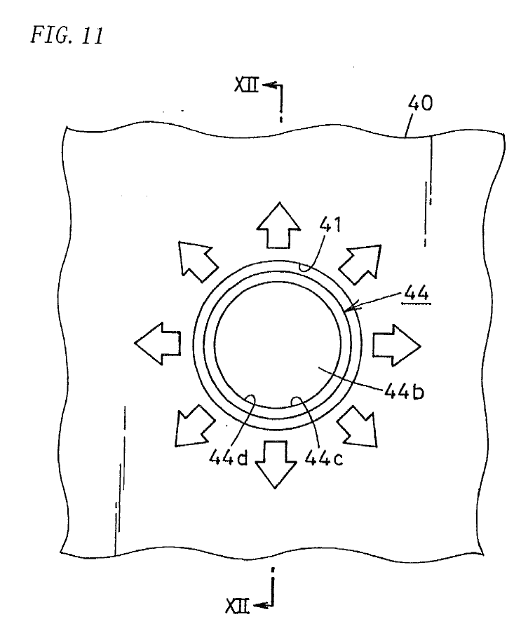

FIGS. 11-13 show a door including the third embodiment of the present invention.

In the front panel of the door 40, a circular opening 41 is formed. A cylindrical storage case 42 forms a handle storage portion 43.

In the handle storage case 42, a circular rear end portion 44b having nearly the same size as the inner section of the handle storage case 42 is fixed to the rear end of a cylindrical portion 44a. An inward projection 44c is provided at the front end of the cylindrical portion 44a. In a handle 44, the inward projection 44c is used as an operating portion 44d. The front end of the cylindrical portion 44a faces an opening 41. The rear end portion 44b can be slightly tilted from a rest position where it contacts the rear wall of the handle storage case 42.

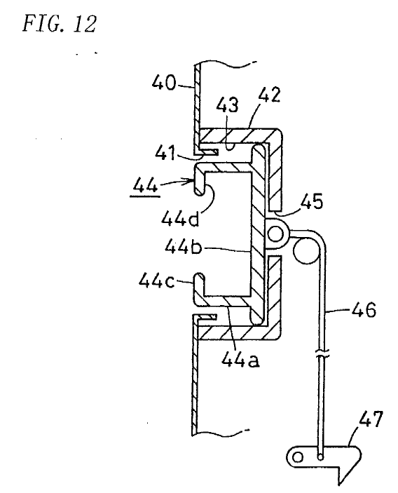

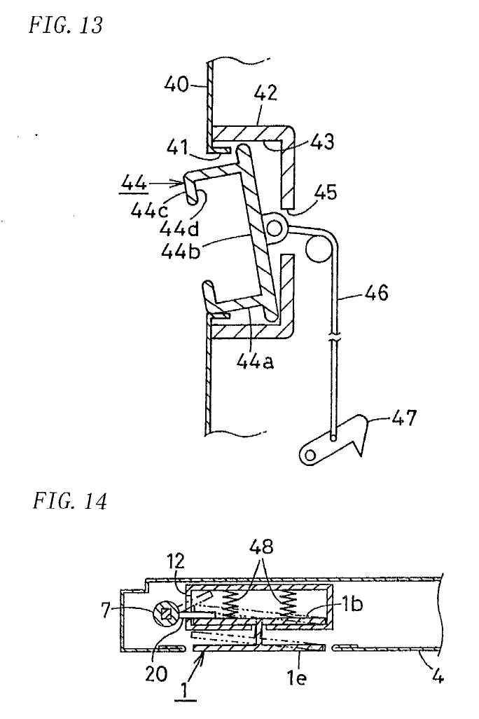

In the middle of the rear surface of the rear end portion 44b, one end of a wire 46 is mounted through an opening 45 in the middle of the handle storage case 42. The other end of the wire 46 is coupled to the middle of a turning latch 47. The latch 47 is able to turn between a rest position in FIG. 12 and a working position in FIG. 13 and is urged toward the rest position by urging means (not shown).

In the embodiment, the wire 46 connects the handle 44 to the latch 47. When the handle 44 is tilted in any direction from the rest position, the wire 46 is pulled to turn the latch from the working position in FIG. 12 to the rest position in FIG. 13.

FIG. 14 is a door including the fourth embodiment of the present invention.

In the embodiment, a brim 1b of a handle 1 is urged forward by compression springs 48,48 in a handle storage case 12 to press any one of upper, lower, left-hand and right-hand edges of a rectangular or circular operating portion 1e at the front end of the handle 1. So the operating portion 1e and brim 1b is tilted from a rest position where the operating portion 1e and brim 1b are in parallel with the front surface of the door 4 to a working position where the handle 1 is tilted. The edge of the brim 1b which moves rearward allows an arm 20 of a latch shaft 7 or a handle holding portion 16 of an operating rod 15 to turn rearward to release latching.

The latch shaft 7 turns in a direction contrary to that in FIG. 7 to release latching.

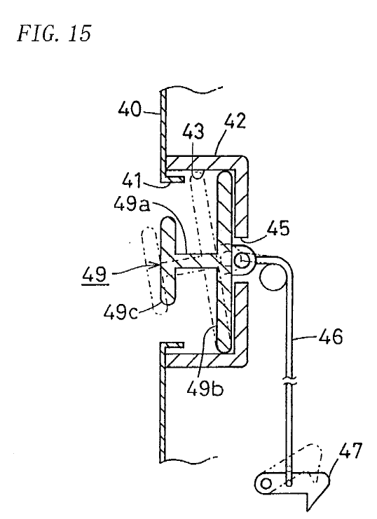

FIG. 15 shows a door including the fifth embodiment of the present invention.

In the embodiment, the handle 44 in the third embodiment is replaced with a handle 49 in which a circular rear end plate 49b which fits in a handle storage case 42 is fixed to the rear end of a short shaft 49a and a circular operating portion 49c projects from the front end of the shaft 49a.

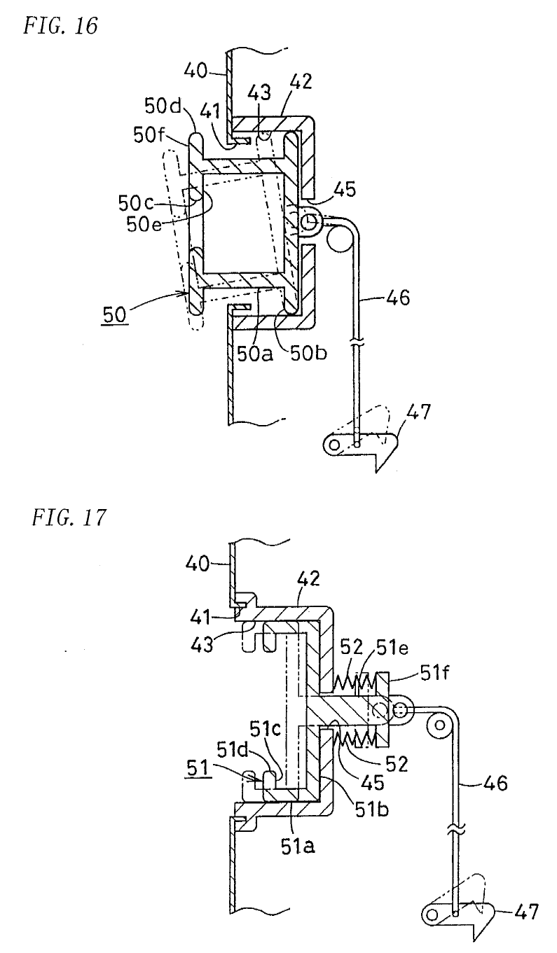

FIG. 16 is a door including the sixth embodiment according to the present invention.

In the embodiment, the handle 44 in the third embodiment is replaced with a handle 50 to which a circular rear end portion 50b which fits in a handle storage case 42 is fixed in the inside of a handle storage case 42 and an inward projection 50a and an outward projection 50d are provided at the front end of the cylindrical portion 50a to form an inward operating portion 50e and an outward operating portion 50f.

The other structure is the same as those in the third embodiment.

FIG. 17 shows a door including the seventh embodiment according to the present invention.

In the embodiment, the handle 44 in the third embodiment is replaced with a handle 51.

In the handle 51, a cylindrical portion 51a which fits in the handle storage case 42 is closed by a rear end portion 51b and an inward projection 51c is provided at the front end of the cylindrical portion 51a to form an operating portion 51d. A shaft 51e projects rearward from the middle of the rear end of the handle storage case 42 through an opening 45 in the middle of the rear end of the handle storage case 42. The shaft 51e is urged rearward by a compression spring 52 between a spring retainer 51f and the rear end of the handle storage case 42. The rear end of the shaft 51e is coupled to a wire 46.

From any one of upper, lower, right-hand and left-hand directions, a hand is brought close to the handle 51 and the projection 51c is pulled by a finger to allow the handle 51 against force of the compression spring 52 to move from a rest position shown by solid lines to a working position shown by dotted lines forward to enable the wire 46 to be pulled thereby releasing latch surely.

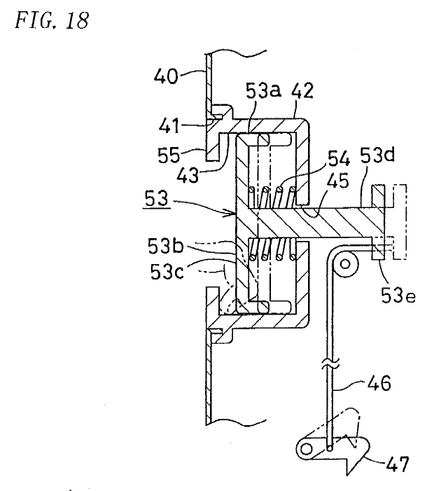

FIG. 18 shows a door including the eighth embodiment according to the present invention.

In the embodiment, the handle 44 in the third embodiment is replaced with a handle 53.

In the handle 53, a front end of a cylindrical portion 53a which fits in a handle storage case 42 is closed by a front end plate 53b to form an operating portion 53c. A shaft 53d which extends from the middle of the rear surface of a front end plate 53b projects rearward through an opening 45 in the middle of the rear end of the handle storage case 42. One end of a wire 46 is mounted to the front surface of a rear end portion 53e of the shaft 51d. The shaft 53d is urged anytime by a compression spring 54 between the rear surface of the front end portion 53b and the bottom of the handle storage case 42.

An inward flange 55 is provided from the front end of the handle storage case 42. The first or second joint of a finger is engaged on the projection 55 allows the operating portion 53c of the handle 53 to move rearward.

The other structure is the same as those in the third embodiment.

From any one of upper, lower, right-hand and left-hand directions, a hand is brought close to the handle 53 and a finger is engaged on the projection 55 at the front end of the handle storage case 42. The first or second joint of the finger presses the operating portion 53c at the front end of the handle 53 rearward to allow the handle 53 by leverage to move from the rest position in solid lines to the working position in dotted lines against force of the compression spring 54 to enable the wire 46 to be pulled, thereby releasing the latch.

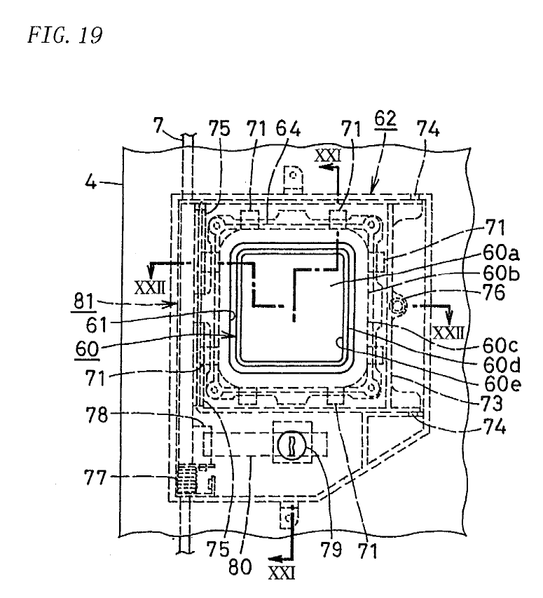

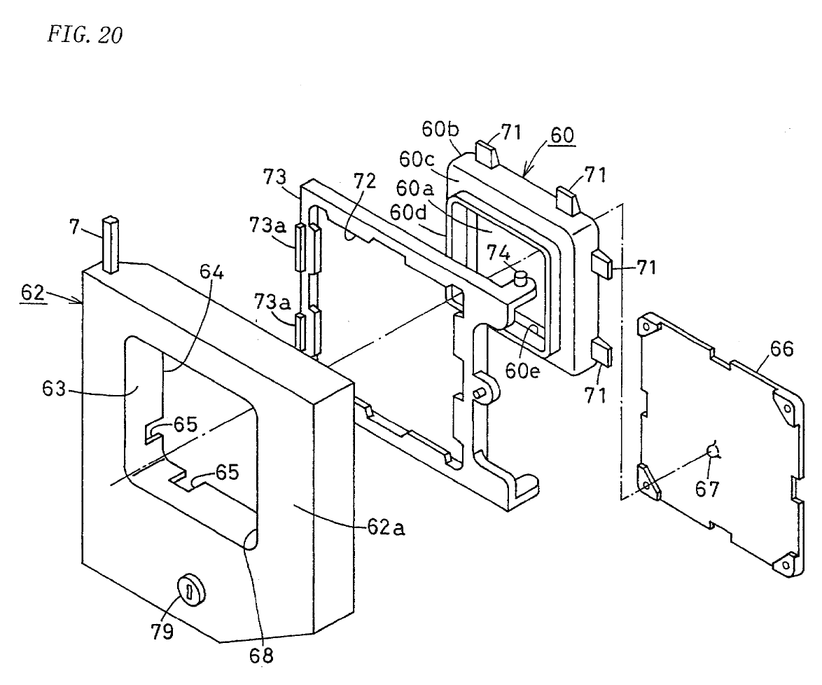

FIGS. 19-22 show a door including the ninth embodiment of the present invention.

A door 4 in FIG. 19 is similar to that in FIG. 3. The right-hand door 4 is pivotally mounted to the right side of the housing 6 of the cabinet B in FIG. 1 with a hinge (not shown).

The door 4 is equipped with what are similar to the latch shaft 7 and latch 8 in FIG. 2. Illustration and description thereof are the same as those in the first embodiment and omitted.

In FIGS. 19-22, a square opening 61 is formed to operate a handle 60 in the middle of a front panel of the right-hand door 4. Behind the opening 61, a box-like thin handle storage case 62 having a square opening 63 is provided.

A rectangular guide frame 64 is disposed on the front edge surrounding the opening 63 in the handle storage case 62. Two rectangular grooves 65,65 are formed in each side of the guide frame 64.

A vertical closing plate 66 is fixed to the rear end of the guide frame 64 with screws at four corners, and a hemispherical projection 67 is provided at the center of the front surface of the closing plate 66.

A handle storage portion 68 comprises the opening 61 of the door 4, handle storage case 62 and closing plate 66.

A handle 60 comprises a vertical square base 60a having a thicken portion, a rectangular portion 60b; an inward portion 60c; and a rectangular projection 60d. The inward portion 60c and the projection 60d form an operating portion 60e.

The rear surface of the middle thicken part of the base 60a has a hemispherical hole 69 in which the hemispherical projection 67 engages. The hemispherical projection 67 and hemispherical hole 69 form a spherical bearing 70. The handle 60 is pivotally mounted to the door 4 to tilt in all radial directions including up-and-down and right-and-left on the hemispherical projection 67 from the rest position where the base 60 is in a substantially upright position. In order that the handle 50 may tilt at the same angle in all radial directions, the rear surface of the handle 60 the top of which is the hemispherical hole 69 is conically shaped.

The hemispherical projection 67 may be provided on the rear surface of the handle 60, and the hemispherical hole 69 may be formed in the middle of the front surface of the closing portion 66.

Two projections 71,71 are provided on each of the upper, lower, right-hand and left-hand outer peripheral surfaces of the rectangular portion 60b of the handle 60 and project to the outside through the two grooves 65,65 of the guide frame 64.

In the right side of the handle storage case 62, the right side of an operating plate 73 is pivotally mounted with vertical shaft 74,74, and has a square opening 72 through which a guide frame 64 and handle 60 therein engages.

A pair of engagement portions 73a,73a is provided on the left side of the operating plate 73 and contacts the rear surface of a pair of upper and lower arms 75,75 projecting from a latch shaft 7 of the handle storage case 62.

On the rear surface of the operating plate 73, the upper, lower, right and left projections 71,71 contact. When the handle 60 is in the rest position, the operating plate 73 is in a rest position where all the projections 71 contact the rear surface of the operating plate 73 in parallel with the base 60a of the handle 60.

From this position, the upper, lower, right and left operating portions 60e of the handle 60 is pulled to allow the handle 60 to tilt into any working position. So the operating plate 73 is turned forward to the working position with any one of the projections 71. With the engagement portions 73a,73a, the arms 75,75 are pushed forward. Thus, in FIG. 2, the latch shaft 7 and latch 8 turn to the disengaged position where the latch 8 is released from the engagement portion 10.

In FIG. 22, a compression spring 76 is disposed between the front surface of the operating plate 73 and a front portion 62a of the handle storage case 62. By the compression spring 76, the operating plate 73 is urged toward the rest position any time, and the handle 60 is urged toward the rest position since all the projections 71 of the handle 60 are pushed.

Specifically, by the single compression spring 76, the operating plate 73 and the handle 60 are both urged toward the rest position.

At the left side of the handle storage case 62, there is a torsion coil spring 77 for urging the latch 8 toward the engagement position where the latch 8 engages with the engagement portion 10 in FIG. 2 and for urging the operating plate 72 toward the rest position.

Another arm 78 projects from the latch shaft 7 under an arm 75. A cylinder lock 79 is mounted to the handle storage case 62 and exposed on the front surface of the door 4. A key (not shown) is inserted into the cylinder lock 79 to move a dead bolt 80 back and force. The left end of the dead bolt 80 goes into a turning track of the arm 80 for locking and gets out of the track for unlocking.

In the embodiment, there is a connecting unit 81 where the latch 8 moves to the disengaged position where the housing 6 leaves the engagement portion 10 when the latch shaft 7 from which the arms 75,75 project allows the operating plate 73 and the latch 8 to move to the working position of the operating plate 73. A latch device comprises the latch 8, connecting unit 81, handle storage case 62, handle 60 and operating plate 73.

How to operate the ninth embodiment will be described.

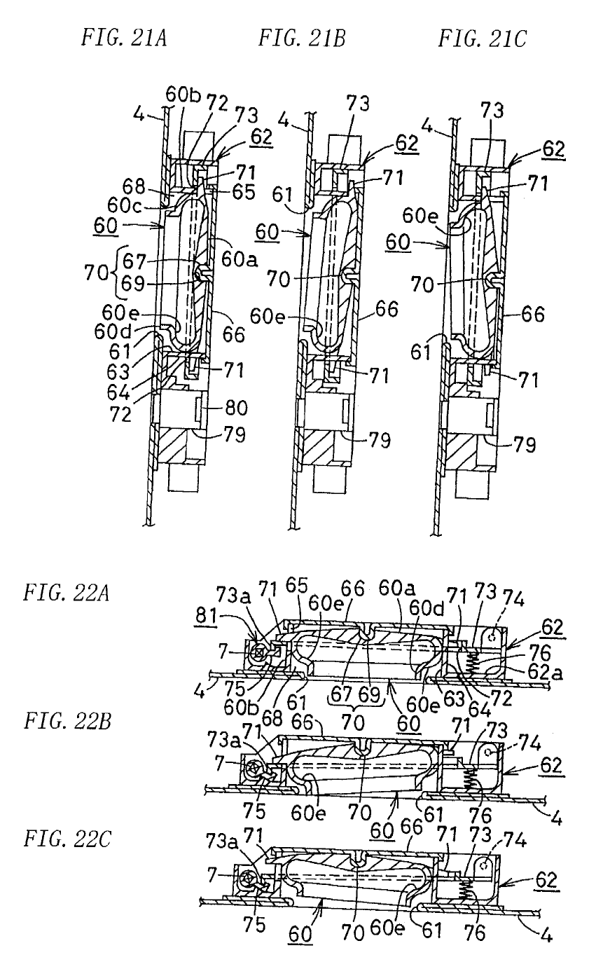

When the handle 60 does not work, the handle 60 is in the rest position in FIGS. 21A and 22A. The latch 8 and latch shaft 7 are in the engagement position as shown by the solid lines in FIG. 2.

From this state, in FIG. 21B, when the lower operating portion 60e is pulled, the handle 60 tilts rearward on the hemispherical projection 67, the operating plate 73 is turned around the shaft 74 with the right projection 71 at the lower end of the handle 60. The arms 75,75 are pushed forward by the engagement portions 73a,73a to allow the latch shaft 7 and latch 8 to turn to the disengaged position as shown by dotted lines in FIG. 2 to allow the door 4 to open.

In FIG. 21C, when the upper operating portion 60e of the handle 60 is pulled, the handle 60 tilts forward about the hemispherical projection 67. With the upper right projection 71 of the handle 60, the operating plate 73 turns to the working position about the shaft 74. With movement of the engagement portions 73a,73a, the arms 75,75 are pushed forward to allow the latch shaft 7 and latch 8 to turn to the disengaged position as shown by the dotted lines to allow the door 4 to open.

In FIG. 22B, when the left side operating portion 60e of the handle 60 is pulled, the handle 60 turns counterclockwise around the hemispherical projection 67. In FIG. 22C, when the right-side operating portion 60e of the handle 60 is pulled, the handle 60 turns clockwise around the hemispherical projection 67. The left-side projection 71 or right-side projection 71 allows the operating plate 73 to turn around the shaft 74 to the engagement position. With motion of the engagement portions 73a,73a, the arms 75,75 are pressed forward to allow the latch shaft 7 and latch 8 to turn to the disengaged position as shown by dotted lines in FIG. 2 to allow the door 4 to open.

Accordingly, even if any one of the upper, lower, right-hand and left-hand operating portions 60e of the handle 60 is pulled, the latch is moved to the disengaged position. Thus, even if the handle 60 is operated from any one of upper, lower, right-hand and left-hand directions, the latch 8 can be released surely, which is convenient.

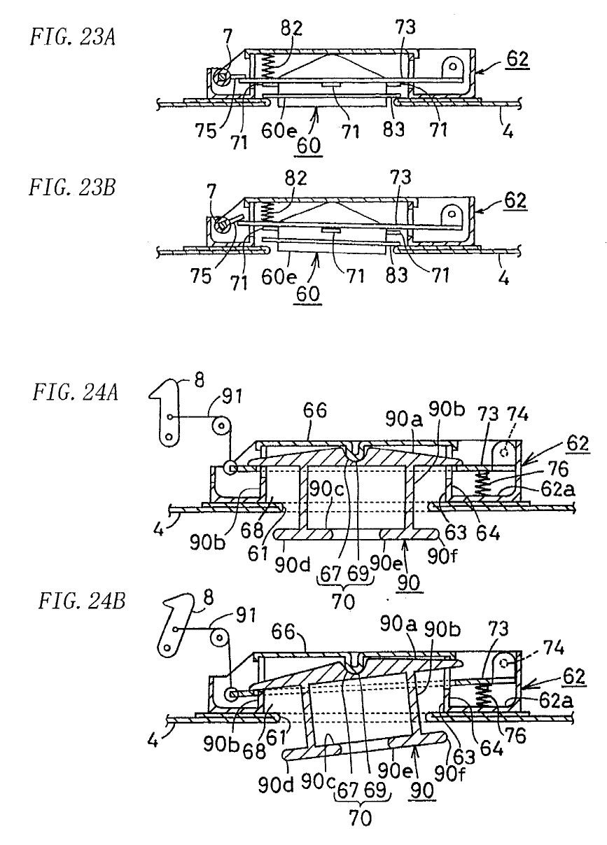

FIG. 23 shows a door including the tenth embodiment of the present invention.

In this embodiment, as shown in FIG. 23A, an operating plate 73 is urged forward by a compression spring 82 in a handle storage case 62. A handle 60 is urged forward via any one of upper, lower, right and left projections 71 contacting the front surface of an operating plate 73. A brim 83 at the front end of the handle 60 contacts the rear surface of the periphery around an opening 61 and a handle 60 is in a rest position where the front end face of the handle 60 and brim 83 is in parallel with the front surface of the door 4. Any one of upper, lower, right and left edges of rectangular or circular operating portion 60e at the front end of the handle 60 is pressed rearward to allow the handle 60 to tilt to a working position in FIG. 23B. The operating plate 73 is turned rearward against the force of a compression spring 82. The left end of the operating plate 73 allows an arm 75 and a latch shaft 7 to turn counterclockwise in FIG. 23A to release latch.

The latch shaft 7 is rotated in a direction opposite to FIG. 22 to release latch.

FIG. 24 shows a door including the eleventh embodiment of the present invention.

In this embodiment, the handle 60 in the tenth embodiment is replaced with a handle 90 in which a cylindrical portion 90b is provided on the front surface of a base 90a similar to the base 60a. An inward projection 90c and an outward projection 90d are provided on the front end of the cylindrical portion 90b.

A wire 91 connects the free end of an operating plate 73 to a latch 8. The operating plate 73 is turned from a rest position in FIG. 24A to a working position in FIG. 24B. The wire 91 is pulled to allow the latch 8 to turn from an engagement position in FIG. 24A to a disengaged position in FIG. 24B.

The others are the same as those in the ninth embodiment.

The foregoing relate to preferred embodiments of the present invention. Variation below may be carried out without departing from the scope of claims.

(a) The right and left handle holding portions 16,16 in the first embodiment extends upward and bends rearward to allow its rear end to contact a middle portion of the brim 1b at each side of the handle 1. The handle 1 tilts in any one of upper, lower right and left directions to allow any one of the right and left handle holding portions 16 to press forward with the brim 1b. So the upper arm 19 may be omitted.

(b) At least the operating portion 1e of the opening 11 and handle 11 in the first and second embodiments may be circular, and the operating portion 1e is provided on the whole inner circumference of the handle 1 to enable the handle 1 to be operated not only from upper, lower, right and left directions but also from intermediate oblique directions.

(c) At least the operating portion 44d of the opening 41 and handle 44 in the third embodiment may be rectangular.

(d) In the ninth embodiment, between pulling of the left-side operating portion 60e of the handle 60 and pulling of the right-side operating portion 60e of the handle 60, there is difference in a distance from a forcing point of the handle 60 to the shaft 74 or moment to make operating force of the handle 60 for releasing latch different. To reduce the difference, for example, the right and left projections 71,17 of the handle 60 is omitted. When the left-side operating portion 60e of the handle 60 is pulled, the operating 73 is pressed forward with the left projections 71,71 of the handle 60. When the right-side operating portion 60e of the handle 60 is pulled, the operating plate 73 is pressed forward with the right projections 71,71 of the handle 60.

(e) At least the operating portion 60e for the opening 61 and handle 60 in the ninth embodiment is circular and is provided on the whole inner periphery of the front opening to allow the handle 60 to be operated not only from upper, lower right and left directions but also from intermediate oblique directions.

(f) In the latch device of the drawer 2 in the cabinet A, instead of the latch shaft 7 disposed at the door turning together with the latch 8, the connecting unit comprises an operating shaft disposed on the front panel 3 to allow the latch to press toward the disengaged position with the bent portion at one end; an arm provided in the operating shaft to turn by the free end of the operating plate to turn the latch to the disengaged position via the operating shaft when the operating plate turns from the rest position to the working position.

1.-21. (canceled)

22. A latch device provided to a door of a housing, comprising:
a latch in the door, the latch engaging with an engagement portion of the housing when the door closes;
a handle storage case;
a handle stored in the handle storage case to move between a rest position in which the door closes and a working position, the handle having an operating portion with which the handle can be operated from any directions in the working position to allow the latch to disengage from the engagement portion;
a urging unit in the handle storage case, the urging unit urging the handle toward the rest position; and
a connecting unit connecting the handle to the latch to disengage the latch from the engagement portion of the housing.

23. The latch device of claim 22 wherein the handle is stored in the handle storage case to move between the front working position and the rear rest position, the handle being always urged by the urging unit toward the rear rest position.

24. The latch device of claim 22 wherein the handle has a corner-cutout-flat portion at a corner to abut on the connecting unit to allow the latch to disengage from the engagement portion of the housing.

25. The latch device of claim 22 wherein the handle has an opening around which the operating portion is provided.

26. The latch device of claim 22 wherein the handle is stored in the handle storage case to move between the front rest position and the rear working position, the handle being always urged by the urging unit toward the front rest position.

27. The latch device of claim 22 wherein the handle is stored in the handle storage case to move between the rest position where the handle is in parallel with a front surface of the door and the working position where one of a pair of edges of the handle is tilted ahead of the other.

28. The latch device of claim 22 wherein the handle has an opening and a brim at a rear end, the operating portion being provided on a front of the opening, the brim contacting a rear end of the handle storage case, an inward brim extending from the handle storage case at a front of the opening to limit tilting of the handle in the handle storage case.

29. The latch device of claim 23 wherein the urging unit comprises an operating rod having a pair of handle holding portions at each end and a torsion coil spring wound on the operating rod to apply rearward turning force to the handle.

30. The latch device of claim 24 wherein the connecting unit comprising a latch shaft one end of which is fixed to the latch to rotate with the latch, an arm horizontally projecting from the latch shaft, the operating portion of the handle being moved by a hand to allow the corner-cutout-flat portion to abut on and push the arm of the latch shaft to allow the latch shaft to turn with the latch to allow the latch to disengage from the engagement portion of the housing.

31. The latch device of claim 24 wherein the urging unit comprising a pair of handle holding portions, an operating rod and a torsion coil spring wound around the operating rod, the connecting unit comprising a vertical operating rod coupled to each of the handle holding portions and a horizontal operating shaft having an arm, the handle being tilted to allow the corner-cutout-flat portion to push the each of the pair of handle holding portions to rotate the operating rod thereby rotating the operating shaft to allow the latch to disengage from the engagement portion of the housing.

32. The latch device of claim 22 wherein the operating portion of the handle comprises a circular edge around a circular opening and can be operated from any positions of the circular opening.

33. The latch device of claim 32 wherein the connecting unit comprises a wire which connects a middle of the handle to the latch, the handle being pulled to allow the latch to disengage from the housing.

34. The latch device of claim 26 wherein the urging unit comprises a compression spring to push the handle forward in the rest position in the handle storage case, the connecting unit comprising a latch shaft having an arm abutting on the handle, the handle being pushed rearward to rotate the latch shaft via the arm to allow the latch to disengage from the housing.

35. A latch device comprising:
a latch disposed in a door to engage with an engagement portion of a housing when the door closes;
a handle storage case;
a handle in the handle storage case, the handle having a projection on an outer periphery to move between a substantially vertical rest position in which the latch engages with the engagement portion and a working position in which the handle can be operated from any directions in the working position to allow the latch to disengage from the engagement portion of the housing;
an operating plate in the handle storage case, the operating plate having an opening in which the handle fits, the operating plate being pushed by the projection of the handle from the rest position to the working position;
an urging unit urging the handle and the operating plate toward the rest position; and
a connecting unit allowing the latch to disengage from the engagement portion of the housing when the operating plate moves to the working position.

36. The latch device of claim 35, further comprising a closing plate behind the handle, the closing plate having a hemispherical projection at a center of a front surface, the handle having a hemispherical hole at a center of a rear surface, the hemispherical projection of the closing plate engaging in the hemispherical hole of the handle to allow the handle to tilt in any directions on the hemispherical projection.

37. The latch device of claim 36 wherein the handle has a plurality of projections on the outer periphery, the plurality of projections abutting on the operating plate when the handle and the operating plate are in the rest position.

38. The latch device of claim 36 wherein the urging unit comprising a compression spring urging the operating plate toward the rest position.

39. The latch device of claim 38 wherein the connecting unit comprises a latch shaft pivotally mounted to the door to rotate together with the latch, and an arm provided on the latch shaft, the arm turning by a free end of the operating plate when the operating plate turns from the rest position to the working position to allow the latch to disengage from the engagement portion of the housing.
